(19) United States
(12) Patent Application Publication
(10) Pub. No.: US 2002/0156953 A1
(43) Pub. Date: Oct. 24, 2002

(54) Dynamic bus inversion method

(76) Inventors: Mark A. Beiley, Chandler, AZ (US); James Breisch, Chandler, AZ (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/794,036

(22) Filed: Feb. 28, 2001

(51) Int. Cl. G06F 13/42

(52) U.S. Cl. 710/105

(57) ABSTRACT

A dynamic bus inversion method transfers successive groups of bit signals across a data communications bus. The method determines the number (A) of bit signals in a current group of bit signals that will transition in state compared to the corresponding bit signals of a previous group of bit signals if the bit signals of the current group are inverted and the number (B) of bit signals in a current group of bit signals that will transition in state compared to the corresponding bit signals of a previous group of bit signals if the bit signals of the current group are not inverted. The bit signals of the current group are inverted before being transferred across the data communications bus if (A) is less than (B).

### BACKGROUND

1. Field of the Invention

This invention relates generally to the transfer of data over a data communications bus. In particular, the present invention relates to bus protocols and to methods of dynamically inverting the data bits being transferred over a data communications bus.

2. Description of the Related Art

Many processing systems, such as computers, typically use high-speed, high-bandwidth, data communication buses to transfer data between different components, such as one or more processors (for example, any one of the microprocessors manufactured in the form of an integrated circuit (IC) chip by Intel® Corporation, of Santa Clara, Calif.), memory subsystems, and input/output subsystems. In many cases, the overall performance of the processing system is constrained as much, if not more, by the speed or bandwidth of the bus(es) used to transfer data among components of the processing system as it is by the speed or performance of the components themselves. This is especially true when the components primarily consist of IC chips and the bus(es) provide communication between two or more IC chips.

There is a constant effort to improve the speed and bandwidth of bus(es) used to transfer data between IC chips in a computer system. A data communication bus of particular concern is the Front Side Bus (FSB) used to transfer data between one or more microprocessors and an controlling IC chip or chipset in a personal computer (PC). But as the front side bus and other data communications buses get faster and wider, signal integrity and power consumption become more significant concerns. Typically, designers have addressed these concerns by reducing the transition speed of the bus buffers in the IC chips so that the rate at which current is drawn when switching between signal states is reduced. But these efforts result in slower edge rates and slow down performance of the bus.

### BRIEF DESCRIPTION OF THE DRAWINGS

A better understanding and appreciation of the foregoing and of the attendant advantages of the present invention will become apparent from the following detailed description of example embodiments of the invention. While the foregoing and following written and illustrated disclosure focuses on disclosing example embodiments of the invention, it should be clearly understood that the same is by way of illustration and example only and is not to be taken by way of limitation.

The following represents brief descriptions of the drawings, wherein:

FIG. 1 is a block diagram showing the major components and data communications buses of an exemplary computer system in which a dynamic bus inversion method according to an example embodiment of the invention may be practiced.

FIG. 2 shows the connection of a front side bus (FSB) in the exemplary computer system of FIG. 1.

FIG. 3 is a flowchart of a dynamic bus inversion method according to an example embodiment of the invention.

### DETAILED DESCRIPTION

While example embodiments of the invention are described herein by reference to a processing system of a particular described architecture and to a particular bus therein, the present invention is applicable for use with all types of data communication buses and with all types of processing systems. Examples of such data communication buses are system buses, front side buses, back side buses, memory buses, and graphics buses. Examples of possible processing systems are personal computers, laptop computers, handheld computers, servers, peripherals, storage devices, and devices for data communications such as data packet routers, etc. For the sake of simplicity, discussions will concentrate mainly on an exemplary computer system having several IC chips interconnected by high-speed, high-bandwidth, data communication buses, although the scope of the present invention is not limited to such an environment. The invention may be practiced in a wide variety of processing systems and with a wide variety of data communication buses.

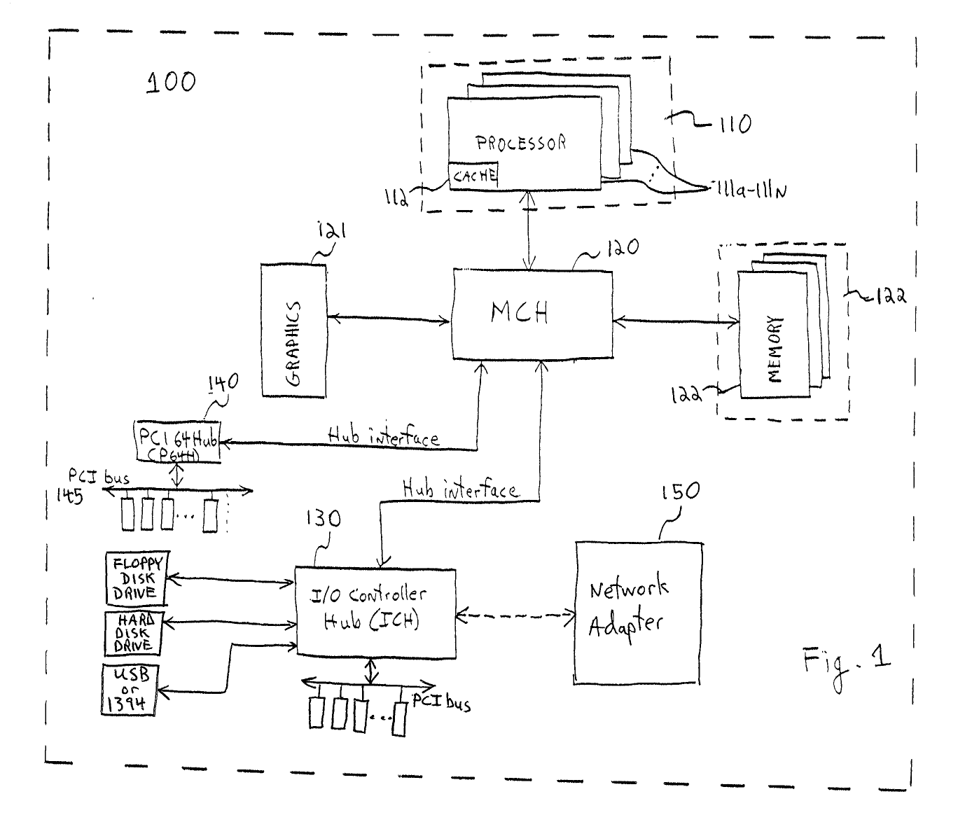

An example of a computer system having components connected by data communication buses is shown in FIG. 1. As shown in FIG. 1, the computer system may comprise a processor subsystem 110 (which may be comprised of a plurality of processors 111a-111n and at least one internal or external (not shown) cache memory 112), a memory controller hub (MCH) 120 connected to the processor subsystem 110 (by a host interface or a front side bus), a highly integrated multi-functional input/output (I/O) controller hub (ICH) 130 connected to MCH 120 by a dedicated 16 bit hub interface, and a PCI 64 bit hub (PCH) bridge 140 also connected to MCH 120 by a dedicated 16 bit hub interface. MCH 120, ICH 130 and P64H 140 may be implemented as separate IC chips in a single chipset.

MCH 120 is connected to a graphics subsystem 121 (possibly including a AGP 4× graphics controller, a local memory and a display device such as a cathode ray tube, liquid crystal display, or flat panel display) by a graphics bus (such as an AGP 2.0 bus), and to a main memory subsystem 122 (storing information and instructions for use by the processor subsystem 110) by a memory bus. The memory subsystem 122 typically includes a control circuit and one or more memory cards or modules populated by at least one dynamic random-access-memory (DRAM) device 123 or the like.

ICH 130 is connected to a number of I/O devices, including possibly a Peripheral Component Interconnect (PCI) bus 135. A firmware hub and various I/O devices (not shown) may be connected to ICH 130, including, for example, Super I/O providing a low pin count (LPC) bus interface with various I/O devices, including a keyboard controller for controlling operations of an alphanumeric keyboard, a cursor control device such as a mouse, track ball, touch pad, joystick, etc., a mass storage device such as a magnetic tape, a hard disk drive (HDD) 132, a floppy disk drive (FDD) 131, a universal serial bus (USB) or 1394 port 133, links for audio and telephony codec(s), and parallel ports to printers, scanners, and display devices.

P64H bridge 140 may operate as an interface between MCH 120 and peripheral PCI bus 145. PCI bus 145 may be a high performance 32 or 64 bit synchronous bus with automatic configurability and multiplexed address, control and data lines as described in the latest version of “PCI Local Bus Specification, Revision 2.2” set forth by the PCI Special Interest Group (SIG) on Dec. 18, 1998 for add-on arrangements (e.g., expansion cards) with new video, networking, or disk memory storage capabilities. For example, PCI bus 145 may operate at 64-bits and 66 MHz or at 32-bits and 33 MHz. Of course, other types of bus architecture and corresponding bridges, such as Industry Standard Architecture (ISA) and Expanded Industry Standard Architecture (EISA) buses may also be utilized.

The invention may of course be practiced in a computer system having a configuration or components different than those of exemplary computer system 100 shown in FIG. 1. For example, an additional component (such as network adapter 150) may be connected directly to ICH 130 by a dedicated hub interface or connected indirectly to MCH 120 as a PCI card on PCI bus 145 interfacing with P64H 140.

A dynamic bus inversion method according to an example embodiment of the invention will now be described as being implemented in the front side bus transferring data between processor subsystem 110 and MCH 120. However, the method may be implemented in any of the other data communications buses of the exemplary computer system shown in FIG. 1 or in any data communications bus of any other processing system. The invention is not limited in its application to a system having an architecture as illustrated in FIG. 1. Indeed, an advantage of the invention is that it may be useful and widely adaptable to many data communication buses. Furthermore, the invention may be practiced in buses connected to a variety of different devices. Each device connected to the bus has what is generically referred to herein as a “bus agent” which is any kind of circuitry which provides and receives the data transferred over the bus.

The front side bus between processor subsystem 110 and MCH 120 may be operable in different modes, where at least one of these modes pumps data multiple times in each clock cycle of the bus. A bus controller in both processor subsystem 110 and MCH 120 organizes and partitions data into byte-oriented transactions so that they can be transmitted on the host interface with a granularity determined by the bus width and the number of times data is pumped in each clock cycle. Of course, notwithstanding the example embodiments, the invention can be used with buses having different bus speeds, and octal or dual pumping instead of quad pumping. The bus may be a point-to-point bus connected between two integrated circuit chips or a multidrop bus connected to more than two integrated circuit chips. In either case, the bandwidth of the point-to-point bus may be optimized to be consistent with the processing speed of the integrated circuits and to minimize pin count.

As an example, the front side bus may be a quad pumped 64 bit wide data bus which transfers a 32 byte (256 bits) cache line in a single clock cycle between a Pentium 4® processor and a 850 chipset from Intel Corporation of Santa Clara, Calif. The cache memory, the read data buffer and pre-fetch buffer in the buffer circuitry of the processor may be configured to hold the 256 bits of data (as well as 16 data inversion bit signals) transferred in a clock cycle. (In addition to the data bits and data inversion bit signals, there are also address signals and control signals associated with the bus but these are not necessarily stored in the buffer circuitry of the processor.)

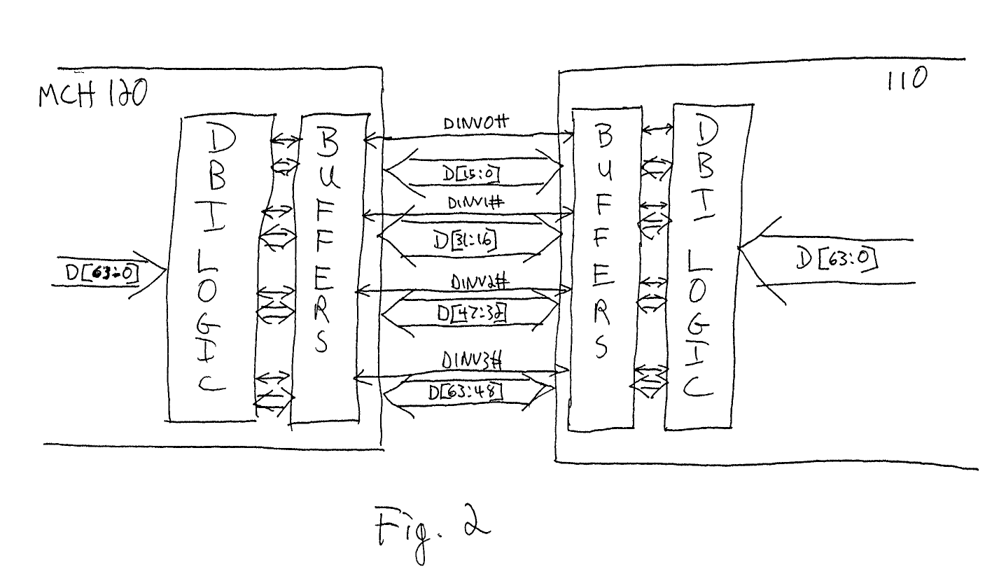

According to the example embodiment, the 64 data bits transferred simultaneously on the bus may be divided into 4 groups of 16 bit signals each. (Alternatively, the bit signals could instead be organized into different size groups (for example, 8 groups of 8 bit signals).) For each group of 16 bit signals, a corresponding data inversion bit signal indicates if the bit signals belonging to that group are inverted on the bus for each quad pumped data phase. The data bit signals and and data inversion bit signals could correspond as follows and as shown in FIG. 2:

| DINV[3:0]# | Data Bits |
|---|---|
| DINV0# | HD[15:0]# |
| DINV1# | HD[31:16]# |
| DINV2# | HD[47:32]# |
| DINV3# | HD[63:48]# |

The bus agent in processor subsystem 110 and the bus agent in MCH 120 have DBI control logic for each transmitted group of 16 bit signals. The DBI control logic for each group of bit signals sets and outputs the data inversion bit signal (DINV) according to an analysis involving the 16 bit signals. If a DINV for a group of bit signals is set active, then the buffer circuitry inverts each one of the bit signals of the corresponding group of data bit signals and passes the active DINV signal together with the inverted data bit signals. If DINV for the group of bit signals is not set active, the data bit signals in the corresponding group of bit signals remains unchanged and the inactive DINV signal is passed along with the unchanged data bit signals. If the DBI control logic is disabled, the DINV is passed inactive. Likewise, it is assumed that other bus agents maintain DINV values inactive while their respective DBI feature is disabled.

The encoding of the data bit signals in each group described above is performed prior to data transmission over the data communications bus. The data is taken from the buffer circuitry and is transferred over the data communications bus at the appropriate timing for the bus. As described above, the outgoing data bit signals are inverted if DINV is set active and are passed without change if DINV is inactive.

The DBI control logic in the receiving bus agent in each device connected to the bus also decodes the data bit signals in each received group of data bit signals in a manner complementing the encoding process. When it receives a clock cycle of data, it monitors each one of the data bit inversion signals (DINV[3:0]) to determine if the bit signals of the corresponding group of data bit signals should be inverted. It inverts the incoming data bit signals of each group of data bit signals if the corresponding DINV signal received for the group is set active, or passes the incoming data bit signals if the corresponding DINV signal for the group of data bit signals is set inactive.

Error correction codes (ECC) may be processed in parallel by the receiving bus agent even when the invention is being practiced. In the event of a single bit error, the erroneous data bit is corrected. However, the corrected data bit isn't inverted by the DBI control logic. The remaining data bits in the same group of data bit signals are inverted (if so instructed by the DBI control logic according to the corresponding DINV signal for the group).

The calculation in the DBI control logic can be complex and thus slow. As a result, an example embodiment of the invention implements the various necessary calculations in a distributed manner to avoid adding time delays to critical data paths. A discrete unit block of logic implements DBI calculations in parallel to check error correction codes for data that is read from memory, such as dynamic random access memory (DRAM).

When driving and receiving data over the bus, the DBI control logic of a bus agent can be used to limit the number of bit signals that are driven to a low voltage and are in the low state on each quad pumped data phase. Whenever the bus agent drives data, the DBI control logic analyzes each group of 16 bit signals. If more than half of the bit signals in the group (more than 8 out of the 16 bit signals in a group according to the example embodiment) would be driven low (active) on the bus in the absence of dynamic bus inversion, then the corresponding data bit inversion signal (DINV internally, DINV# on the bus) is asserted (set active) and each data bit signal of the group is inverted in the buffer circuitry prior to being driven on the bus.

According to this dynamic bus inversion method, there will almost always be the case that a maximum of one half of the bit signals in a single group are active (logic “1” internally, or in a low state “0” on the bus). If no more than half of the bit signals are active, the bit signals in the group are not inverted. In instances of error correction, it is possible that there will never be more than 9 active bit signals in a group of 16 bit signals. This technique minimizes the worse case power consumption for the on-die bus terminations in the buffer circuitry. It is optimal for reducing the direct current (DC) consumed by the GTL style drivers in the buffer circuitry.

However, the number of bit signals that transition in a given clock cycle affects the signal integrity of all of the bit signals. This is commonly referred to as simultaneous switching outputs (SSO). SSO affects overshoot, undershoot, and ringback, which affects alternating current (AC) timings and can cause functional failures. The total power consumed by a GTL style bus is comprised of both AC and DC components. The above-described technique reduces the DC component of power consumption by a factor of 2, but it only reduces the DC component.

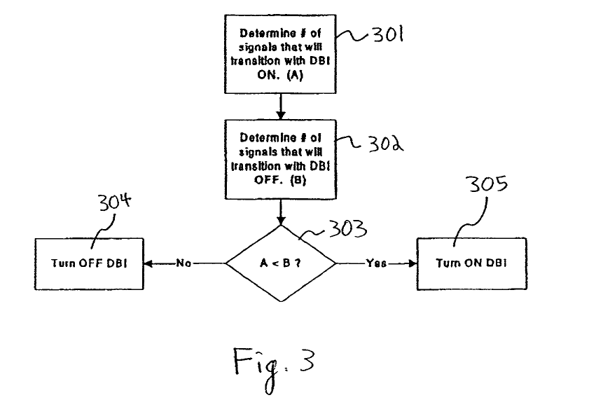

FIG. 3 illustrates the logic algorithm for a dynamic bus inversion method according to an example embodiment of the invention. As is apparent, the method specifies when to turn dynamic bus inversion on and off. However, the activation of the data bus inversion control signal is determined by whichever state (on or off) would minimize the number of signal transitions from the prior state of the bus. The DBI control logic holds the previous state (high or low) of each bus signal until the next state is received. A calculation is done to determine the number of required transitions with data bus inversion on (step 301) and the number of required transitions with data bus inversion off (step 302). The DBI control logic determines which DBI state would result in the lowest number of transitions (step 403). The determination is used to control the data bus inversion control signal provided to the buffer circuitry and, consequently, whether or not the bus operates in a dynamic bus inversion mode.

The dynamic bus inversion method according to the example embodiment of the invention reduces the AC component of power consumption by up to a factor of 2. In current bus designs, the DC component comprises approximately two thirds of the total power consumption, so the dynamic bus inversion method according to the example embodiment of the invention increases power relative to the current method. However, as bus frequencies get higher, the AC component will become more significant, and the dynamic bus inversion method according to the example embodiment of the invention will provide lower total power consumption in addition to improved signal integrity. In summary, the dynamic bus inversion method according to the example embodiment of the invention provides significantly improved signal integrity, and may provide greater power savings for future data communications buses.

Other features of the invention may be apparent to those skilled in the art from the detailed description of the example embodiments and claims when read in connection with the accompanying drawings. While the foregoing and following written and illustrated disclosure focuses on disclosing example embodiments of the invention, it should be understood that the same is by way of illustration and example only, is not to be taken by way of limitation and may be modified in learned practice of the invention. While the foregoing has described what are considered to be example embodiments of the invention, it is understood that various modifications may be made therein and that the invention may be implemented in various forms and embodiments, and that it may be applied in numerous applications, only some of which have been described herein. It is intended by the following claims to claim all such modifications and variations.

1. A dynamic bus inversion method for transferring successive groups of bit signals across a data communications bus, said method comprising:
determining the number (A) of bit signals in a current group of bit signals that will transition in state compared to the corresponding bit signals of a previous group of bit signals if the bit signals of the current group are inverted;
determining the number (B) of bit signals in a current group of bit signals that will transition in state compared to the corresponding bit signals of a previous group of bit signals if the bit signals of the current group are not inverted; and
inverting the bit signals of the current group before being transferred across the data communications bus if (A) is less than (B).

2. The method recited in claim 1, wherein a control signal is generated which indicates whether or not the bit signals of the current group should be inverted.

3. The method recited in claim 2, wherein the control signal is provided to buffer circuitry transferring the current group of bit signals across the data communications bus.

4. The method recited in claim 2, wherein a plurality of groups of bit signals are simultaneously transferred across the data communications bus and a respective control signal is generated for each one of the plurality of groups of bit signals simultaneously transferred across the data communications bus.

5. The method recited in claim 1, wherein each one of the successive groups of bit signals are transferred over the data communications bus during a single clock cycle.

6. The method recited in claim 1, wherein the data communications bus transfers the successive groups of bit signals between integrated circuit chips.

7. A logic algorithm embodied in a processing system, said logic algorithm, when executed, causing said processing system to carry out a method of transferring successive groups of bit signals across a data communications bus, said method comprising:
determining the number (A) of bit signals in a current group of bit signals that will transition in state compared to the corresponding bit signals of a previous group of bit signals if the bit signals of the current group are inverted;
determining the number (B) of bit signals in a current group of bit signals that will transition in state compared to the corresponding bit signals of a previous group of bit signals if the bit signals of the current group are not inverted; and
inverting the bit signals of the current group before being transferred across the data communications bus if (A) is less than (B).

8. The logic algorithm recited in claim 7, wherein a control signal is generated which indicates whether or not the bit signals of the current group should be inverted.

9. The logic algorithm recited in claim 8, wherein the control signal is provided to buffer circuitry transferring the current group of bit signals across the data communications bus.

10. The logic algorithm recited in claim 8, wherein a plurality of groups of bit signals are simultaneously transferred across the data communications bus and a respective control signal is generated for each one of the plurality of groups of bit signals simultaneously transferred across the data communications bus.

11. The logic algorithm recited in claim 7, wherein each one of the successive groups of bit signals are transferred over the data communications bus during a single clock cycle.

12. The logic algorithm recited in claim 7, wherein the data communications bus transfers the successive groups of bit signals between integrated circuit chips.

13. A bus agent configured to transfer successive groups of bit signals across a data communications bus, said bus agent comprising:
buffer circuitry receiving and sending successive groups of bit signals across said data communications bus, said buffer circuitry adapted to controllably invert said bit signals prior to transfer; and
a logic circuit controlling said buffer circuitry, said logic circuit:
determining the number (A) of bit signals in a current group of bit signals that will transition in state compared to the corresponding bit signals of a previous group of bit signals if the bit signals of the current group are inverted;
determining the number (B) of bit signals in a current group of bit signals that will transition in state compared to the corresponding bit signals of a previous group of bit signals if the bit signals of the current group are not inverted; and
if (A) is less than (B), sending a control signal to said buffer circuitry instructing the buffer circuitry to invert the bit signals of the current group of bit signals before being transferred across the data communications bus.

14. The bus agent recited in claim 13, wherein the control signal is transferred across the data communications bus simultaneously with the bit signals of the current group.

15. The bus agent recited in claim 14, wherein a plurality of groups of bit signals are simultaneously transferred across the data communications bus and a respective control signal is generated for each one of the plurality of groups of bit signals simultaneously transferred across the data communications bus.

16. The bus agent recited in claim 13, wherein each one of the successive groups of bit signals are transferred over the data communications bus during a single clock cycle.

17. The bus agent recited in claim 13, wherein the bus agent comprises part of an integrated circuit chip.
